(19) United States
(12) Patent Application Publication
(10) Pub. No.: US 2007/0004355 A1
(43) Pub. Date: Jan. 4, 2007

(54) Apparatus, system, and method for multi-class wireless receiver

(76) Inventors: Issy Kipnis, Berkley, CA (US); Scott Chiu, Folsom, CA (US); David Westberg, Balsta (SE); Jan Rapp, Hasselby (SE); Jonas Johansson, Stockholm (SE)

Correspondence Address: KACVINSKY LLC;C/O INTELLEVATES, P.O. BOX 52050, MINNEAPOLIS, MN, 55402, US

(21) Appl. No.: 11/172,235

(22) Filed: Jun. 29, 2005

(51) Int. Cl. H04B 1/18

(52) U.S. Cl. 455/190.1; 455/313

(57) ABSTRACT

Apparatus, system, and method for multi-class wireless receiver are described. The multi-class receiver includes a first down-converter coupled to an input port, a filter coupled to the first-down converter, and a second down-converter coupled to the filter. In a first mode, the filter is configured as a first filter and the second down-converter is disabled. In a second mode, the filter is configured as a second filter and the second down converter is enabled. The system includes a wireless module and a wireless transceiver in communication with the wireless module. The method includes receiving multi-class RF signals, converting at least a first class of RF signals in a first mode of operation, and converting at least a second class of RF signals in a second mode of operation with said multi-class receiver.

### BACKGROUND

Radio Frequency Identification (RFID) is one of many identification technologies used to identify a target object. The heart of an RFID system lies in an information carrying module known as a tag. A tag may include a microchip attached to an antenna and may be packaged such that it can be applied to the target object. The tag receives and transmits signals to and from a reader, most often packaged in the form of a transceiver. The tag may contain a unique serial number as well as other information, such as a customer account number. Tags may be implemented in many forms. For example, a tag may have a barcode label printed thereon, may be mounted inside a carton or may be embedded within the target object.

RFID tags may be implemented as active, passive or semi-passive devices. RFID-Tags function in response to coded RF signals received from a base station transceiver. An active tag includes its own energy supply, such as a battery, that may serve as a partial or complete power source for the tag's circuitry and antenna. Batteries may be replaceable or are sealed units. A passive tag is powered by the RFID reader itself and does not contain a battery. It communicates by reflecting an incident RF carrier back to the reader. When radio waves from the reader are encountered by a passive RFID tag, the antenna within the tag forms an induced voltage from which the tag may draw power from to energize its circuits. The tag then transmits the encoded information stored in the tag's memory by backscattering the carrier of the reader. A semi-passive RFID tag uses a battery to operate its internal circuitry, but also relies on backscattering communication.

Reading is the process of retrieving data stored on an RFID tag by propagating radio waves to the tag and converting the waves propagate from the tag to the reader into data. Information is transferred as the reflected signal is modulated by the tag according to a particular programmed information protocol. Protocols for RFID tags may be categorized in terms of tag to reader over the air interfaces. Three common interface classes are Class-0 (read-only), Class-1 (read/write), and UHF Generation-2 (read/write), for example. UHF Generation-2 provides some improvement upon existing Class-0 and Class-1 standards for worldwide operation and improved performance, for example. ISO18000 standard series RFID tags cover both active and passive RFID technologies.

Conventional RFID receivers or transceivers use multiple separate receiver chains for each class of tags (e.g., Class-0, Class-1, and UHF) in a given environment. Conventional RFID receiver implementations provide different baseband filters for Class-0 and Class-1 tags because Class-0 modulation makes active implementations of a Class-0 filter difficult. Class-0 signals are modulated as 2.25 and 3.25 MHz sub-carriers. These high frequency sub-carriers with relatively small separation require a high-Q filter. To achieve a proper high-Q, Class-0 filters are commonly implemented using large and expensive discrete components that are difficult to integrate. Separate receiver chains and filters for each class of RFID tag duplicates Class-0 and Class-1 demodulation circuitry at the receiver.

### BRIEF DESCRIPTION OF THE DRAWINGS

FIG. 1 illustrates a block diagram of one embodiment of an RFID system 100.

FIG. 2 illustrates one embodiment of receiver 200.

FIG. 3A graphically illustrates one embodiment of a spectral diagram of a signal spectrum 300.

FIG. 3B graphically illustrates one embodiment of a spectral diagram of a signal spectrum 310.

FIG. 3C graphically illustrates one embodiment of a spectral diagram of a signal spectrum 320.

FIG. 3D graphically illustrates one embodiment of a spectral diagram of a signal spectrum 330.

FIG. 4 illustrates a logic flow 400 in accordance with one embodiment.

### DETAILED DESCRIPTION

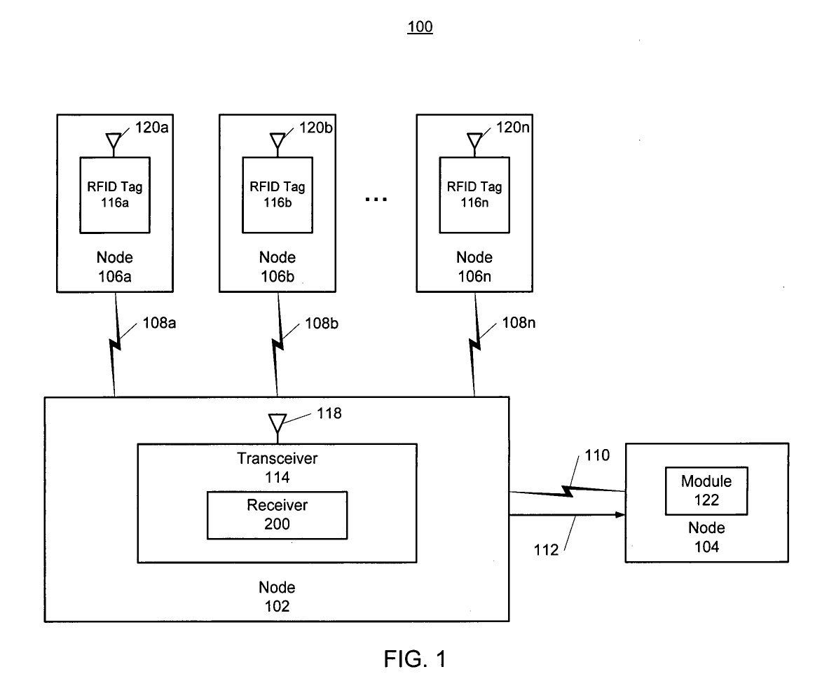

FIG. 1 illustrates a block diagram of one embodiment of an RFID system 100. System 100 may comprise, for example, a communication system having multiple nodes. A node may comprise any physical or logical uniquely addressable entity in system 100. These nodes may include wireless communication modules such as, for example, RFID tags, as well transceivers for reading and writing information to and from the tags. The RFID tags may comprise information associated with target objects located throughout system 100. The embodiments are not limited in this context.

The nodes of system 100 may be arranged to communicate different types of information by way of RFID tag protocols. Information exchanged in various embodiments of RFID system 100 may comprise any data associated with target objects. For example, such information may be exchanged through active RFID tags and may comprise data associated with locating, tracking, and safeguarding target objects, including, for example, locating warehouse inventory items, tracking containers with manifest data and safeguarding containers with security type RFID tags, tracking equipment maintenance-parts, tracking vehicles, and locating position of target objects, for example. Additionally, such information may be exchanged through passive RFID tags and may comprise data associated with accessing target systems such as electronic access control, mobile speed pass at gasoline stations and toll booths, ski pass, luggage tags, passport control, and supply chain item/carton/pallet tracking, among other similar applications, for example. Furthermore, system 100 may comprise, for example, variations and combinations of active and passive RFID tags. Information may comprise data associated with battery assisted passive tags, combined passive (short range) and active (long range) tags, transmit only tags (beacon tag), and real-time locating systems, for example.

The nodes of RFID system 100 may communicate media and control information in accordance with one or more custom or standard protocols. A protocol may comprise a set of predefined rules or instructions to control how the nodes communicate information between each other. As previously discussed, there are several basic forms of over the air interface protocols to enable RFID tag to reader communication, such as, for example, Class-0 (read-only), Class-1 (read/write), and UHF Generation 2 (read/write), among other protocols, for example. The protocol may be defined by one or more protocol standards as promulgated by a standards organization. These may include protocols defined by international RFID standards, such as, International Standards Organization (ISO) RFID standards, International Electrotechnical Commission (IEC) RFID standards, Electronic Product Code (EPC) RFID Standards, International Telecommunications Union (ITU), and Universal Postal Union (UPU) RFID standards, for example. The protocols may be defined by National Standards Organizations, such as American National Standards Institute (ANSI) for the United States, British Standards Institute (BSI) for the United Kingdom, and/or other standards for example. The protocols also may be industrial or proprietary custom protocols. The embodiments, however, are not limited in this context.

Portions of RFID system 100 may be implemented as a wired communication system, a wireless communication system, or any combination thereof. Although system 100 may be illustrated using a particular communications media by way of example, it may be appreciated that the principles and techniques discussed herein may be implemented using any type of RFID communication media and accompanying technology. The embodiments, however, are not limited in this context.

When implemented as a wireless system, system 100 may include one or more wireless nodes comprising wireless communication modules, such as, for example, RFID tags, interrogators, transceivers, and the like. These wireless nodes may be arranged to communicate information over one or more types of wireless communication media. An example of a wireless communication media may include portions of a wireless spectrum, such as the radio-frequency (RF) spectrum. The wireless nodes may include components and interfaces suitable for communicating information signals over a designated wireless spectrum, such as one or more antennas, wireless transmitters/receivers (“transceivers”), amplifiers, filters, control logic, and so forth. Examples for the antenna may include an internal antenna, an omni-directional antenna, a monopole antenna, a dipole antenna, a lead-frame antenna, an end-fed antenna, a circularly polarized antenna, a patch antenna, a plane-inverted F antenna, a micro-strip antenna, a diversity antenna, a dual antenna, an antenna array, and so forth. The embodiments are not limited in this context.

Referring again to FIG. 1, RFID system 100 may comprise nodes 102, 104, 106a-106n, for example. Although FIG. 1 is shown with a limited number of nodes arranged in a certain topology, it may be appreciated that system 100 may include additional or fewer nodes arranged in any topology desired for a given implementation. Node 102 may communicate with nodes 106a-106n via RFID wireless communication links 108a-108n. In addition node 102 may communicate with node 104 via wireless communication link 110, wired link 112, or any combination thereof, for example. In one embodiment, wireless communication link 110 also may comprise a wireless RFID link, for example. In one embodiment, transceiver 114 communicates with module 122. In one embodiment, module 122 may comprise a wireless device such as an RFID tag, wireless telephone (e.g., cellular telephone), computer, wireless device, cellular telephone or any other wired or wireless communication device described herein. The embodiments are not limited in this context.

In one embodiment, RFID system 100 may comprise node 102. Node 102 may comprise, for example, an RFID reader comprising a communication element. Among other elements and functions, the communication element may include a wireless transceiver 114, for example, to communicate between node 102 and nodes 106a-106n, for example. In one embodiment, transceiver 114 may comprise antenna 118 and may be configured to communicate with one or more wireless modules, such as, for example, RFID tags 116a, 116b, 116n at nodes 106a, 106b, 106n, respectively, for example. Each RFID tag 116a, 116b, 116n comprises an antenna 120a, 120b, 120n, respectively.

RFID tags 116a-116n may communicate with node 102 by way of multiple over the air interface protocols, for example. In one embodiment, RFID tags 116a-116n may comprise any one of or any combination of Class-0 (read-only), Class-1 (read/write), UHF Generation 2 (read/write), and ISO18000 classes of RFID tags discussed above, among other RFID tag classes, for example. In one embodiment, RFID tags 116a-116n may comprise active, passive, and/or semi-passive RFID tags, for example.

In general operation, RFID system 100 may comprise an RFID system to dynamically track and monitor target objects located therein. In one embodiment, system 100 may communicate information between node 102 and node 104, and between node 102 and nodes 106a-106n, at any time, and simultaneously read and write information from and to RFID tags 116a-116n, respectively. For example, transceiver 114 may read and write information from and to RFID tags 116a-116n to track target objects such as serial numbers of target objects and components contained therein.

In one embodiment, transceiver 114 may comprise a receiver 200, for example. In one embodiment, receiver 200 may comprise a multi-class receiver to read information from multiple classes of RFID tags, for example. In one embodiment, receiver 200 may comprise a multi-class receiver to perform direct down-conversion of baseband Class-1 RFID tag signals and a double down-conversion of subcarrier Class-0 RFID tag signals, for example. In one embodiment, receiver 200 may perform a direct down-conversion of baseband Class-1 RFID tag signals and a double down-conversion of subcarrier Class-0 RFID tag signals in a single chain. In one embodiment, receiver 200 may provide smaller, lower cost, and power efficient receiver than alternative implementations requiring a separate receiver chain for each class of RFID tags to be read. Embodiments of single chain receiver 200 for multi-class applications may be fully integrated in a single integrated circuit component, for example. In one embodiment, the size and cost of receiver 200 may be reduced by providing the functionality for direct down-conversion and double down-conversion in one building block. In one embodiment, receiver 200 may comprise a baseband Analog to Digital Converter (ADC) for multiple classes of RFID. In one embodiment, for example, the ADC may be a complex ADC. For example, in one embodiment, one ADC may be provided to receive an in-phase (I) signal component and one ADC may be provided to receive a quadrature (Q) signal component.

As indicated previously, in one embodiment Class-1 RFID tags have a baseband information bandwidth of <1 MHz and thus receiver 200 may comprise a direct down-conversion portion. In contrast, in one embodiment Class-0 RFID tags may be subcarrier modulated at substantially 2.25 and 3.25 MHz. Therefore, conventional direct conversion architectures for Class-0 RFID tag signals require baseband filters and ADCs with substantially 3.3 MHz bandwidths. These are not practical because they consume more power. In one embodiment, however, receiver 200 may comprise a complex baseband filter for Class-0 operation configured as a complex band-pass filter may be centered at substantially 2.75 MHz, with a single-lobe filter bandwidth of approximately 1 MHz. Accordingly, the 2.25 and 3.25 MHz Class-0 sub-carrier signals would be within the pass band of such complex baseband filter. After a first down-conversion and complex baseband filtering, receiver 200 then performs a second down-conversion on the Class-0 signals at substantially 3 MHz with the same <1 MHz bandwidth ADC utilized for Class-1 RFID tags, for example. Although the embodiments are described as being implemented at specific frequencies with components that are operational at such specific frequencies, the embodiments are not limited in this context.

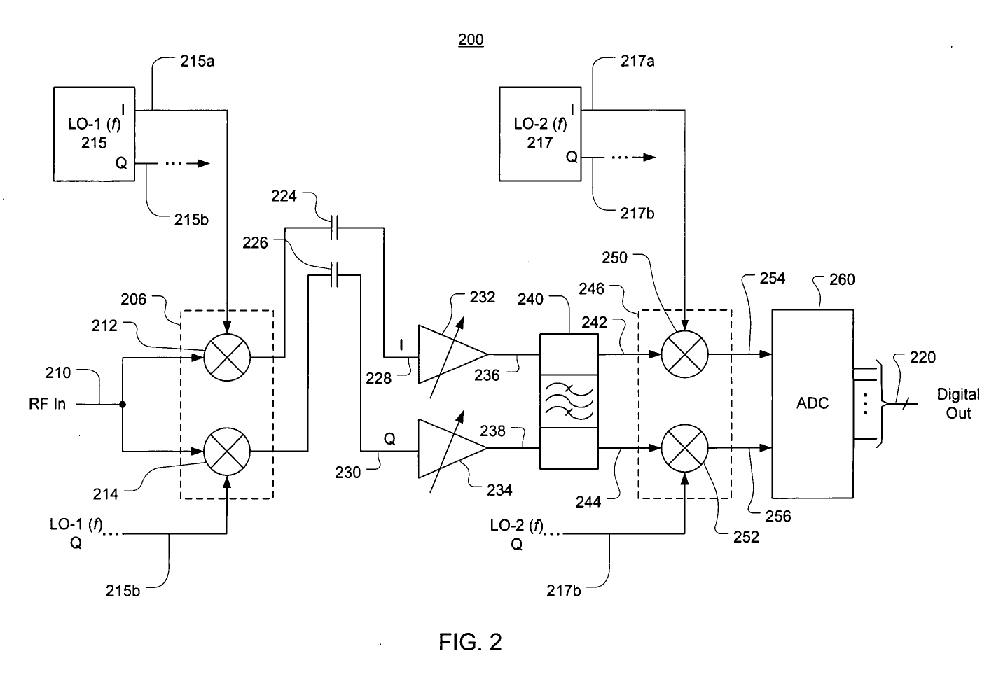

FIG. 2 illustrates one embodiment of receiver 200. As indicated previously, in one embodiment, instead of using separate baseband filters for Class-0 and Class-1 RFID tags, receiver 200 utilizes a single chain multi-class receiver to process signals received therefrom. In one embodiment, receiver 200 may comprise an RF input port 210 and a digital output port 220, for example. RF signals from Class-0 and Class-1 RFID tags may be received at input port 210 and are provided to an input down converter 206 comprising a first mixer 212 and a second mixer 214. A first local oscillator 215 (LO-1) may be provided to generate in-phase (I) and quadrature (Q) frequencies for mixing to perform the first down-conversion. In one embodiment, LO-1 215 frequency may be set to an Ultra High Frequency (UHF) frequency. For example, in one embodiment, LO-1 215 frequency may be set to a UHF frequency of approximately 900 MHz. A first in-phase LO-I frequency 215a may be provided to first mixer 212. A second quadrature-phase LO-Q frequency 215b may be provided to second mixer 214. Thus, RF signals received at input port 210 are converted to I and Q components by first and second mixers 212, 214 and LO-I, LO-Q LO-1 frequencies 215a, 215b, respectively. Direct current (DC) blocking capacitors 224, 226 remove the DC component of the I/Q baseband signals. After the blocking capacitors 224, 226 remove the DC component, the I/Q baseband signals are provided to input 228 of I-RF amplifier 232 and input 230 of Q-RF amplifier 234, respectively. The outputs 236, 238 of I/Q RF amplifiers 232, 234, respectively, are provided to baseband filter 240. The I/Q-outputs 242, 244 of baseband filter 240 are provided to an output down converter 246 comprising a third mixer 250 and fourth mixer 252. In various embodiments, first and second mixers 212, 214 may be implemented as half-complex mixers, full-complex mixers, among others, without limiting any one embodiment in this context.

In one embodiment, a second local oscillator 217 (LO-2) may be provided to generate in-phase (I) and quadrature (Q) frequencies for mixing to perform a second down-conversion. In one embodiment, LO-2 217 frequency may be set to 3 MHz, for example. A first in-phase LO-I frequency 217a may be provided to third mixer 250 and a second quadrature-phase LO-Q frequency 217b may be provided to fourth mixer 252 to perform the second down conversion, for example. Output 254 of third mixer may be provided to an ADC. In one embodiment, for example, output 254 of third mixer 252 may be provided to ADC 260, which may be implemented as a complex ADC. For example, in one embodiment, ADC 260 may be configured to receive an in-phase (I) signal component and a quadrature (Q) signal component.

In one embodiment, ADC 260 may comprise a complex ADC, for example. Output 256 of fourth mixer 252 also may be provided to ADC 260. A digital output form representing the converted input RF signal appears at the output port 220 of ADC 260.

In operation, one embodiment of receiver 200 receives multi-class RFID tag signals (e.g., Class-0 and Class-1 RFID tag signals) at RF input 210 and performs a direct down-conversion of baseband Class-1 RFID tag signals and performs a double down-conversion of subcarrier Class-0 RFID tag signals. In one embodiment, receiver 200 enables the use of the same baseband ADC 260 for all classes of RFID tag signals that otherwise would need to operate at higher speeds and use more power, for example.

In Class-1 mode of operation, one embodiment of receiver 200 may perform a direct down-conversion of Class-1 RFID signals having a baseband information bandwidth of <MHz, for example. In Class-1 mode of operation, baseband filter 240 may be configured as a real low pass filter with a bandwidth of <<MHz. Further, in this mode, second down-converter 246 is disabled and third, and fourth mixers 250, 252 are latched and operate as buffers. The direct down-converted Class-1 signals then may be provided to ADC 260. As indicated previously, in one embodiment, ADC 260 has a bandwidth of <1 MHz.

In Class-0 mode of operation, one embodiment of receiver 200 may perform a double down conversion of Class-0 RFID tag signals that are subcarrier modulated at 2.25 and 3.25 MHz, for example. As indicated previously, in one embodiment, LO-2 217 frequency may be set to 3 MHZ and may be applied to second down converter 246 (e.g., third and fourth mixers 250, 252). Input down converter 206 performs a first down-conversion of the Class-0 RFID signals received at RF input 210. In Class-0 mode of operation, baseband filter 240 may be configured as a complex band-pass filter centered at 2.75 MHz with a single-lobe filter bandwidth of approximately 1 MHz such that the 2.25 and 3.25 MHz sub-carriers are within the pass band of baseband filter 240. A second 3 MHz down-conversion is then performed at down converter 250 to down-convert both 2.25 MHZ and 3.25 MHz sub-carriers at the output of mixers 250, 252 to baseband. The baseband signals, then may be further processed by ADC 260 with a bandwidth of <1 MHz.

In one embodiment, receiver 200 may be integrated as part of an Integrated Circuit (IC) of multi-class RFID tag filters. In one embodiment receiver 200 may be low power, small, and low cost. Embodiments of receiver 200 share all receiver modules so that Class-0 and Class-1 RFID tags may be demodulated without duplicating circuitry, for example.

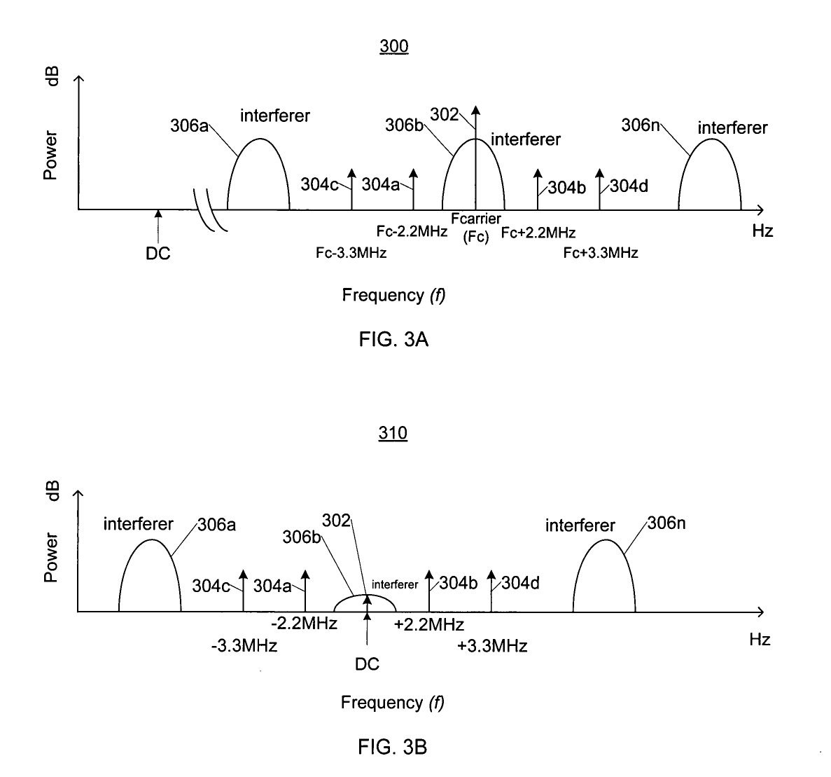

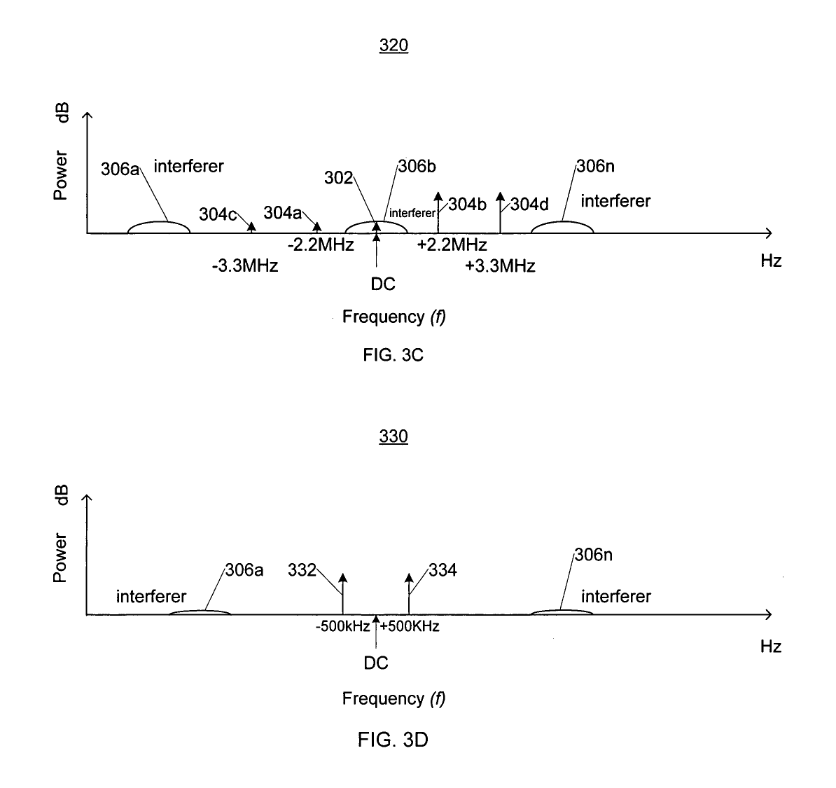

FIG. 3A graphically illustrates one embodiment of a spectral diagram of a Class-0 RFID signal spectrum 300 before processing by receiver 200 (FIG. 2) including interference frequencies spectrum. The vertical axis represents signal power or strength in decibels (dB) and the horizontal axis represents frequency in Hertz (Hz). Spectral diagram 300 appears at RF input 210 of receiver 200 (FIG. 2). Spectral diagram 300 also shows interference signals that also may appear at RF input 210. As indicated previously, Class-0 RFID tags are subcarrier modulated at 2.25 and 3.25 MHz at a given carrier frequency F_{carrier} (F_{c}). Thus signal spectrum 300 appearing at RF input 210 includes F_{c} signal strength 302 at the carrier frequency, and signal strength at (F_{c}−2.25) MHZ side lobe 304a, (F_{c}+2.25) MHZ side lobe 304b, (F_{c}−3.25) MHZ side lobe 304c, and (F_{c}+3.25) MHZ side lobe 304d, for example. In addition to the desired signal spectrum 302, 304a-d, the RF input 210 also will be subject to various interference signals shown as interferers 306a, 306b, and 306n, for example, where “n” may be any number. All of these signals are present at the RF input 210 and are provided to input down converter 206 (FIG. 2), for example. Those skilled in the art will appreciate that these concepts apply to subcarrier modulation techniques using a variety of carrier frequencies and, therefore, the embodiments are not limited in this context.

FIG. 3B graphically illustrates one embodiment of a spectral diagram of a Class-0 RFID signal spectrum 310 after processing by input down converter 206 (FIG. 2) including interference frequencies. Signal spectrum 310 appears after DC blocking capacitors 224, 226 at inputs 228, 230 of I/Q-RF amplifiers 232, 234 (FIG. 2). As shown, signal spectrum 310 has been shifted about the DC level after the first down conversion and DC blocking by capacitors 224, 226. Signal spectrum 310 is provided to I/Q RF amplifiers 232, 234 and subsequently to inputs of complex baseband filter 240 (FIG. 2). As shown, interferer 306b and carrier signal strength 302 have been significantly reduced.

FIG. 3C graphically illustrates one embodiment of a spectral diagram of a Class-0 RFID signal spectrum 320 after complex baseband filtering by baseband filter 240 (FIG. 2) centered at 2.75 MHz. Spectrum 320 appears at baseband filter outputs 242, 244 before the inputs to output down converter 246 (FIG. 2). As shown, complex baseband filtering by baseband filter 240 (FIG. 2) significantly attenuates interferers 306a-n, and passes the Class-0 frequency spectrum 302, 304a-d. Signal spectrum 320 is then provided to output down converter 246 (FIG. 2). As shown, interferer 306b and carrier signal strength 302 have been significantly reduced. It can be appreciated that in one embodiment, a complex polyphase filter may be provided that is fully symmetric around the center frequency, i.e., in this example +2.75 MHz. Accordingly, all signals below +2 MHz ay be significantly attenuated as the passband would pass signals 304b and 304d and signals 304a and 204c would be attenuated by the complex polyphase filter.

FIG. 3D graphically illustrates one embodiment of a spectral diagram of a Class-0 RFID signal spectrum 330 after output down converter 246 (FIG. 2). Signal spectrum 320 appears at output down converter 246 outputs 254, 256 (FIG. 2). As shown, output down converter 246 with a 3 MHZ LO I/Q frequency provides subcarrier spectrum 332 at −750 kHz and a subcarrier spectrum 334 at +250 kHz for a <1 MHz bandwidth. The spectrums 332, 334 are provided to inputs 254, 256, respectively, of ADC 260. Thus ADC 260 with a bandwidth <1 MHz may be used to convert Class-0 RFID tag signals that are subcarrier modulated at 2.25 and 3.25 MHz at a given carrier frequency F_{carrier} (F_{c}). As shown, interferer 306b and carrier signal strength 302 have been completely removed. It can be appreciated that in one embodiment, the second down conversion may not provide a lot of selectivity, for example. If required a digital filter may be provided to improve the selectivity but that may increase the receive latency and reduce the maximum theoretical read rate of Class-0 devices.

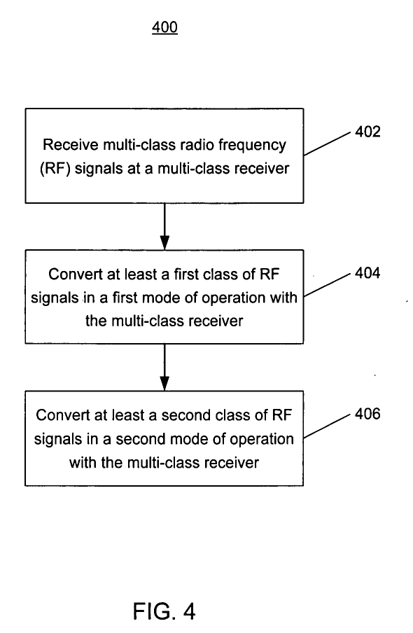

FIG. 4 illustrates one embodiment of a logic flow 400. Logic flow 400 may be representative of the operations executed by one or more apparatuses and systems described herein, such as RFID system 100 and receiver 200. As shown, receiver 200 in system 100, for example, may be configured to receive multi-class radio frequency (RF) signals (402). In one embodiment, receiver 200 may be a multi-class receiver.

Accordingly, receiver 200 converts at least a first class of RF signals in a first mode of operation (404). This may comprise to first down convert the first class of RF signals and then filter the down-converted RF signals. The first down conversion may comprise mixing the first class RF signals with a first local oscillator frequency. In one embodiment, the filter may comprise a low pass filter. In one embodiment, the filter may comprise a band-pass filter.

Receiver 200 then converts at least a second class of RF signals in a second mode of operation (406). This may comprise to down convert the band-pass filtered RF signals. In one embodiment, the second down conversion may comprise mixing the band-pass filtered signals with a second local oscillator signal. In one embodiment, the second down conversion may comprise mixing the band-pass filtered signals with a 3 MHz second local oscillator signal.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data speeds, and other performance constraints. In another example, an embodiment may be implemented as dedicated hardware, such as a circuit, an application specific integrated circuit (ASIC), Programmable Logic Device (PLD) or digital signal processor (DSP), and so forth. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a first down-converter coupled to an input port to convert radio frequency (RF) signals;
a filter coupled to said first-down converter; and
a second down-converter coupled to said filter;
wherein, in a first mode, said filter is configured as a first filter and said second down-converter is disabled; and
wherein, in a second mode, said filter is configured as a second filter and said second down converter is enabled.

2. The apparatus of claim 1, wherein in said first mode, said first filter is configured as low pass filter to convert RF signals comprising baseband information having a first bandwidth.

3. The apparatus of claim 2, wherein said RF signals are provided by Class-1 radio frequency identification (RFID) tags.

4. The apparatus of claim 1, wherein in said second mode, said second filter is configured as a band pass filter and a local oscillator frequency is provided to said second down converter to convert RF signals that are sub-carrier modulated.

5. The apparatus of claim 4, wherein said RF signals are provided by Class-0 RFID tags.

6. The apparatus of claim 1, comprising an analog to digital converter (ADC) coupled to said second down converter.

7. A system, comprising:
a wireless module; and
a wireless transceiver in communication with said wireless module, said transceiver to include a multi-class receiver to perform at least a direct down conversion of a first class of radio frequency (RF) signals and to perform a double down conversion of least a second class of RF signals.

8. The system of claim 7, wherein said wireless module comprises at least any one of a Class-0 and a Class-1 radio frequency identification (RFID) tag.

9. The system of claim 7, wherein said multi-class receiver is configured in a first mode to read said first class of RF signals and is configured in a second mode to read said second class of RF signals.

10. The system of claim 7, wherein said multi-class receiver comprises:
a first down-converter coupled to convert said first and second class of RF signals;
a filter coupled to said first-down converter, and
a second down-converter coupled to said filter;
wherein, in a first mode, said filter is configured as a first filter and said second down-converter is disabled; and
wherein, in a second mode, said filter is configured as a second filter and said output down converter is enabled.

11. The system of claim 9, wherein in said first mode, said first filter is configured as a low pass filter to convert RF signals comprising baseband information having a first bandwidth.

12. The system of claim 9, wherein in said second mode, said second filter is configured as a band pass filter and a local oscillator frequency is provided to said second down converter.

13. The system of claim 1, comprising an analog to digital converter (ADC) coupled to said second down converter.

14. A method, comprising:
receiving multi-class radio frequency (RF) signals by a multi-class receiver,
converting at least a first class of RF signals in a first mode of operation with said multi-class receiver, and
converting at least a second class of RF signals in a second mode of operation with said multi-class receiver.

15. The method of claim 13, wherein converting at least a first class of RF signals in a first mode of operation comprises:
first down converting said first class of RF signals;
filtering said down-converted RF signals;

16. The method of claim 14, wherein said first down converting comprises mixing said first class RF signals with a first local oscillator frequency.

17. The method of claim 14, wherein said filtering comprises low pass filtering.

18. The method of claim 14, wherein filtering comprises band-pass filtering.

19. The method of claim 17, comprising second down converting said band-pass filtered RF signals.

20. The method of claim 18, wherein said second down converting comprises mixing said band-pass filtered signals with a second local oscillator signal.

21. The method of claim 19, wherein said second down converting comprises mixing said band-pass filtered signals with a substantially 3 MHz second local oscillator signal.

22. A multi-class receiver, comprising:
a first class receiver to convert continuous baseband information; and
a second class receiver to convert sub-carrier tone information.

23. The multi-class receiver of claim 21, wherein said first class receiver comprises a direct-down converter.

24. The multi-class receiver of claim 22, wherein said direct-down converter is configured as a real low-pass filter.

25. The multi-class receiver of claim 21, wherein said second class receiver comprises a double-down converter.

26. The multi-class receiver of claim 24, wherein said double-down converter is configured as a complex band-pass filter.

27. The multi-class receiver of claim 24, wherein said double-down converter comprises:
a first down-converter configured as a first band-pass filter comprising a single lobe bandwidth to pass said baseband information; and
a second down-converter configured as a second band-pass filter to pass said subcarrier tone information.
